(19) United States
(12) Patent Application Publication
(10) Pub. No.: US 2026/0110774 A1
(43) Pub. Date: Apr. 23, 2026

(54) METHOD AND SYSTEM FOR CONDUCTING A POWER MEASUREMENT OF A PULSED EM SIGNAL

(71) Applicant: Rohde & Schwarz GmbH & Co. KG, Munich (DE)

(72) Inventors: Maximilian BOGNER, Munich (DE); Steffen NEIDHARDT, Dorfen (DE); Gerhard HAMBERGER, Griesstaett (DE)

(21) Appl. No.: 18/924,627

(22) Filed: Oct. 23, 2024

(51) Int. Cl. G01S 7/40; G01S 13/02

(52) U.S. Cl. CPC G01S 7/4008; G01S 13/02

(57) ABSTRACT

The present disclosure relates to a method for conducting a power measurement of a pulsed electromagnetic, EM, signal which is emitted by a device-under-test, DUT, in an unknown frequency band. The method comprises: performing a plurality of relative power measurements of the pulsed EM signal in different frequency ranges by switching at least one narrowband filter in a measurement path for the EM signal, wherein respective relative power values of the EM signal are recorded for the different frequency ranges; determining the frequency band of the pulsed EM signal by comparing the relative power values of the EM signal recorded in the different frequency ranges; and performing an absolute power measurement of the EM signal at the determined frequency band using a power detector which is calibrated to the frequencies of the frequency band.

### TECHNICAL FIELD

The disclosure relates to a method and a system for conducting a power measurement of a pulsed electromagnetic (EM) signal which is emitted by a device-under-test, such as a radar sensor.

### BACKGROUND ART

Radar sensors can detect the distance and the speed of objects in an environment by emitting radar signals into the environment and capturing reflections of the signals. For example, such radar sensors are an essential technology for advanced driver assistance systems.

Testing of radar sensors is important to understand their behavior under varying conditions and to make sure that the sensors work properly. Such tests often comprise a power measurement, where the power of the emitted radar signal is determined.

Conducting precise power measurements requires some knowledge about the radar sensor under test (RUT), especially about the frequency band used by the RUT. However, sometimes the power measurements are performed by a person who does not have this knowledge. Using a spectrum analyzer to determine the frequency band of the RUT prior to a power measurement is expensive and time consuming.

### SUMMARY

Thus, there is a need to provide an improved method and system for conducting a power measurement of an EM signal, which avoid the above-mentioned disadvantages.

These and other objectives are achieved by the embodiments provided in the enclosed independent claims. Advantageous implementations of the present disclosure are further defined in the dependent claims.

According to a first aspect, the disclosure relates to a method for conducting a power measurement of a pulsed electromagnetic (EM) signal which is emitted by a device-under-test (DUT) in an unknown frequency band. The method comprises: performing a plurality of relative power measurements of the pulsed EM signal in different frequency ranges by switching at least one narrowband filter in a measurement path for the EM signal, wherein respective relative power values of the EM signal are recorded for the different frequency ranges; determining the frequency band of the pulsed EM signal by comparing the relative power values of the EM signal recorded in the different frequency ranges; and performing an absolute power measurement of the EM signal at the determined frequency band using a power detector which is calibrated to the frequencies of the frequency band.

This achieves the advantage that that the frequency band of the DUT can be determined in an efficient manner and subsequently a power measurement at said frequency band can be carried out. Thus, no prior knowledge about the frequency band used by the DUT is required.

The relative power values might not represent the absolute power (i.e., actual power level) of the EM signal at the respective frequency ranges. This is because an absolute power measurement might not be feasible when using the narrowband filter. However, by comparing the relative power values recorded at the different frequency ranges, the spectral position of the frequency band can be determined. For instance, the relative power value is largest in the frequency range that correlates with the frequency band of the DUT. The absolute power of the EM signal can then be determined in a subsequent measurement at the frequencies of the frequency band.

The DUT can be a radar sensor, such as an automotive radar sensor. The pulsed EM signal can be an RF signal or more specifically a radar signal.

In an implementation form, the same power detector is used for the relative power measurements and the absolute power measurement. For example, both relative and absolute power measurements are carried out one after another by the same measurement system.

In an implementation form, to perform the plurality of relative power measurements at the different frequency ranges, a number of narrowband filters with different passbands are alternately switched in the measurement path for the EM signal.

For example, a power measurement is conducted with each narrowband filter. The narrowband filters can be bandpass filters.

In an implementation form, the number of narrowband filters is arranged in a filter bank.

In an implementation form, to perform the plurality of relative power measurements at the different frequency ranges, the frequency of the EM signal is stepwise or continuously shifted and then forwarded to the at least one narrowband filter.

In an implementation form, the frequency of the EM signal is stepwise or continuously shifted by means of a tunable local oscillator and a mixer.

In an implementation form, the method comprises, switching from the narrowband filter to a broadband filter in the measurement path for the EM signal when performing the absolute power measurement.

In an implementation form, the method comprises: additionally determining out-of-band emissions of the DUT by comparing the relative power values of the EM signal recorded in the different frequency ranges.

In an implementation form, the power detector comprises at least one envelope detector and/or at least one analog-to-digital converter (ADC).

In an implementation form, the power detector comprises a plurality of envelope detectors and a plurality of ADCs.

In case the EM signal is forwarded via multiple narrowband filters simultaneously, the output of each filter could be forwarded to one of the envelop detectors and ADCs.

In an implementation form, the power detector comprises a power divider configured to feed portions of a received signal to the plurality of envelope detectors and ADCs.

In an implementation form, the method comprises: calibrating the power detector by feeding at least one calibration signal to the power detector, wherein the at least one calibration signal has known signal characteristics, and correlating measurement results of the power detector to the known signal characteristics of the calibration signal.

For example, a lookup-table or a calibration curve for the power detector can be generated based on said correlation. The calibration can be carried out by the manufacturer of the power detector.

According to a second aspect, the disclosure relates to a system for conducting a power measurement of a pulsed electromagnetic (EM) signal which is emitted by a device-under-test (DUT) in an unknown frequency band. The system comprises: at least one narrowband filter; and a power detector configured to perform a plurality of relative power measurements of the pulsed EM signal in different frequency ranges, wherein the at least one narrowband filter is switched in a measurement path for the EM signal during the plurality of relative power measurements; wherein the power detector is configured to record respective relative power values of the EM signal for the different frequency ranges. The system further comprises a processor configured to determine the frequency band of the pulsed EM signal by comparing the relative power values of the EM signal recorded in the different frequency ranges; wherein the power detector is configured to perform an absolute power measurement of the EM signal at the determined frequency band, wherein the power detector is calibrated to the frequencies of the frequency band.

According to a third aspect, the disclosure relates to a method for determining out-of-band emissions of a device-under-test (DUT) which emits a pulsed electromagnetic (EM) signal in a known frequency band. The method comprises: performing a plurality of relative power measurements of the pulsed EM signal in different frequency ranges by switching at least one narrowband filter in a measurement path for the EM signal, wherein respective relative power values of the EM signal are recorded for the different frequency ranges; wherein the different frequency ranges are within a defined frequency range before and/or after the known frequency band of the EM signal; and determining the out-of-band emissions of the DUT by comparing the relative power values of the EM signal recorded in the different frequency ranges.

This achieves the advantage that out-of-band emissions of the DUT, such as a radar sensor that operates at a known frequency band, can be efficiently detected.

### BRIEF DESCRIPTION OF THE DRAWINGS

The above-described aspects and implementation forms of the present disclosure will be explained in the following description of specific embodiments in relation to the enclosed drawings, in which:

FIG. 1 shows a flow diagram of a method for conducting a power measurement of a pulsed EM signal emitted by a DUT according to an embodiment;

FIG. 2 shows a flow diagram of a method for calibrating the power detector according to an embodiment;

FIG. 3 shows a schematic diagram of a system for conducting a power measurement of a pulsed EM signal emitted by a DUT according to an embodiment; and

FIG. 4 shows a flow diagram of a method for determining out-of-band emissions of a DUT according to an embodiment.

### DETAILED DESCRIPTIONS OF EMBODIMENTS

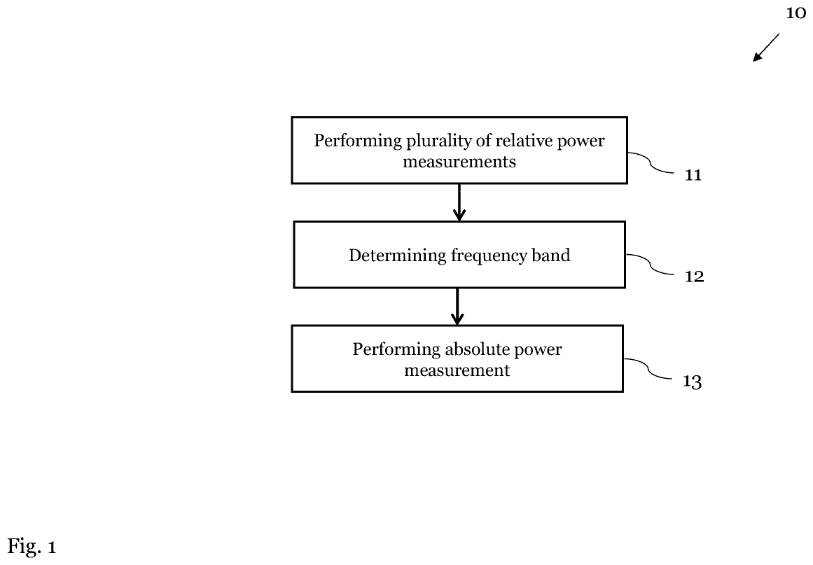

FIG. 1 shows a flow diagram of a method 10 for conducting a power measurement of a pulsed electromagnetic (EM) signal emitted by a DUT according to an embodiment. The EM signal is a signal in an unknown frequency band.

The method 10 comprises the steps of: performing 11 a plurality of relative power measurements of the pulsed EM signal in different frequency ranges by switching at least one narrowband filter in a measurement path for the EM signal, wherein respective relative power values of the EM signal are recorded for the different frequency ranges; determining 12 the frequency band of the pulsed EM signal by comparing the relative power values of the EM signal recorded in the different frequency ranges; and performing 13 an absolute power measurement of the EM signal at the determined frequency band using a power detector which is calibrated to the frequencies of the frequency band.

For instance, the pulsed EM signal occupies a frequency band and is a time discrete signal. The individual relative power values of the EM signal, which are recorded via the narrowband filter, might not represent the actual power level of this signal at the respective frequencies due to the settling time of the narrowband filter. However, comparing these relative power values allows to determine the spectral position of the frequency band. For example, the relative power value is largest in the frequency range that correlates with the frequency band of the DUT. In other words: the frequency band can be detected in the frequency range with the maximum relative power value.

For example, a respective relative power value of the EM signal is recorded at each of the different frequency ranges; and the frequency band of the pulsed EM signal is determined 12 by comparing the relative power values of the EM signal recorded at each of the frequency ranges.

After detecting the frequency band in this way, the absolute power value (i.e., the actual power level) of the EM signal can be measured in a subsequent step. Thereby, the narrowband filter can be switched out of a measurement path. This enables a more precise power measurement of the radiated EM signal. Thereby, frequency specific calibration data of the power detector for the determined frequency band can be used to accurately determine the absolute power value.

The absolute power measurement of the EM signal may provide the actual power level of the signal. In comparisons the relative power measurement only provide relative power values (e.g., relative power levels) that are comparable to each other, but do not represent the actual power level at the respective frequency ranges.

The DUT can be a radar-under-test (RUT) such as a radar sensor, in particular an automotive radar sensor. The pulsed EM signal can be an RF signal or more specifically a radar signal.

The EM signal can be an RF signal, in particular a radar signal. The EM signal can be a CW signal, a chirp signal or an OFDM (orthogonal frequency-division multiplexing) radar signal. The EM signal can be in one out of several known frequency bands.

For instance, due to regulations, there is only a limited number of possible frequency bands of the EM signal, e.g. 76-77 GHz or 79 GHz. Which of these frequency bands is used by the DUT can be unknown to a user when initiating the method 10. The frequency band used by the DUT can be accurately determined in step 12 by detecting which of the different frequency ranges yields a maximum relative power value. For instance, it can be assumed that the frequency band of the DUT lies in this frequency range.

The same power detector can be used for the relative power measurements and for the absolute power measurement. For instance, the narrowband filter can be switched out and a broadband filter can be switched into the measurement path for the EM signal when conducting the absolute power measurement.

For example, both relative and absolute power measurements are carried out one after another by the same measurement system. Thereby, the relative power measurements can take more time than the absolute power measurement. For instance, eleven relative power measurements are carried out at eleven frequency ranges. However, the number of relative power measurements and the exact frequency ranges could be adapted according to the requirements and the type of DUT.

To perform the plurality of relative power measurements at the different frequency ranges, a number of narrowband filters with different passbands can be alternately switched in the measurement path for the EM signal. For instance, a low number of narrowband filters could be used to determine in which of a number of possible frequency bands the DUT operates in.

In addition or alternatively, to perform the plurality of relative power measurements at the different frequency ranges, the frequency of the EM signal can be stepwise or continuously changed, e.g. shifted, and then forwarded via one narrowband filter to the power detector. For instance, a mixer and local oscillator (e.g., an NCO) are used to shift (i.e., sweep) the frequency of the EM signal. When detecting a maximum relative power value in this way, the frequency band of the EM signal can be deducted from the known frequency of the local oscillator at this measurement and the known characteristics of the narrowband filter.

When comparing the relative power values of the EM signal recorded in the different frequency ranges to determine 12 the frequency band, it is also possible to detect any out-of-band emissions of the DUT. Such out-of-band components of the EM signal could be visible as smaller peaks at certain frequency ranges. By detecting such out-of-band emissions, it can be evaluated if the DUT operates within a certain specification.

When conducting the absolute power measurement, a frequency response of the absolute power measurement can be corrected based on the calibration of the power detector. In particular, the power detector is calibrated for performing power measurements at the frequencies of the frequency band.

The power detector can comprise at least one envelope detector and/or at least one analog-to-digital converter (ADC) as will be explained for the system below.

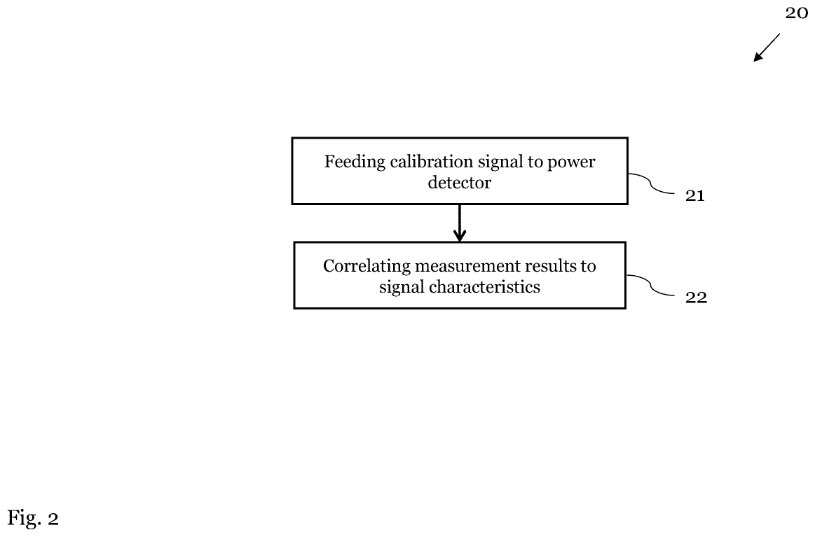

FIG. 2 shows a flow diagram of a method 20 for calibrating the power detector according to an embodiment. The calibration method comprises: feeding 21 at least one calibration signal to the power detector, wherein the at least one calibration signal has known signal characteristics, and correlating 22 measurement results of the power detector to the known signal characteristics of the calibration signal.

The known signal characteristics may refer to the frequency spectrum of the calibration signal.

For instance, this calibration can be carried out prior to the steps of the method 10 shown in FIG. 1, e.g. by a manufacturer of the power detector. By means of this calibration, a lookup-table or calibration curve for correcting power values based at different frequencies can be generated.

The calibration signal can be a CW signal or a known comb signal, or a signal generated by a golden device that outputs a more wideband signal with well-known characteristics which includes all frequency bands typically used by DUTs.

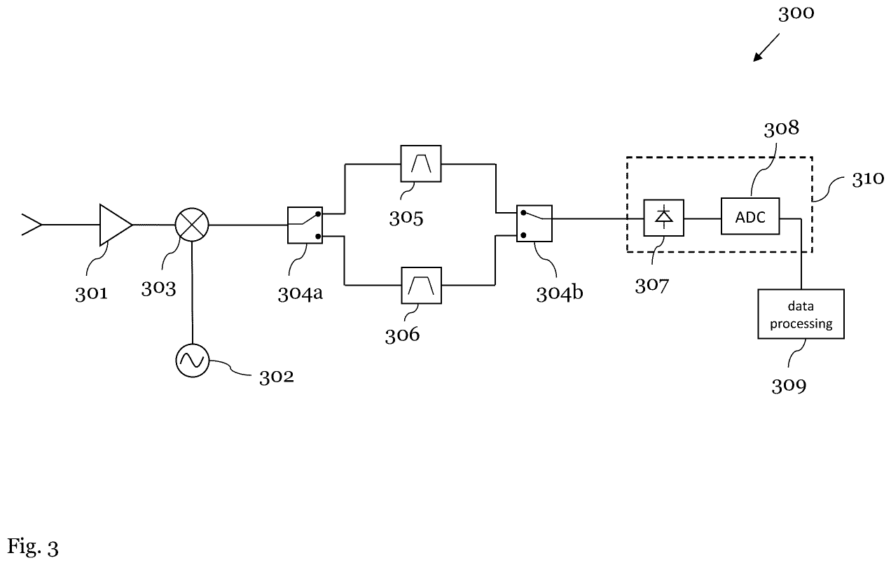

FIG. 3 shows a schematic diagram of a system 300 for conducting a power measurement of the pulsed EM signal in the unknown frequency band that is emitted by the DUT according to an embodiment. For instance, the above-described method 10 can be carried out by the system 30 shown in FIG. 3.

The system 30 comprises the at least one narrowband filter 305 and the power detector 310. The power detector 310 is configured to perform the plurality of relative power measurements of the pulsed EM signal in different frequency ranges, wherein the at least one narrowband filter 305 is switched in a measurement path for the EM signal during the plurality of relative power measurements. The power detector 310 is configured to record respective relative power values of the EM signal for the different frequency ranges. The system 300 further comprises a processor 309 configured to determine the frequency band of the pulsed EM signal by comparing the relative power values of the EM signal recorded in the different frequency ranges. The power detector 310 is further configured to perform the absolute power measurement of the EM signal at the determined frequency band, wherein the power detector 310 is calibrated to the frequencies of the frequency band.

In the system 300 shown in FIG. 3, the same power detector 310 is used for the measurement of the relative and the absolute power values respectively levels of the EM signal. Different filters 305, 306 can be switched into the signal path of the EM signal depending on measuring the absolute or the relative power values (respectively levels).

For instance, when measuring the relative power values, the small band filter 305 is switched into the signal path and when measuring the absolute power value, the wide band filter 306 is switched into the signal path. It is also possible to switch the wide band filter 306 into the signal path and perform one power measurement prior to performing the relative power measurements, just to check whether an EM signal is present at all. The exact shape and bandwidth of the filters 305, 306 can depend on the application, e.g. the DUT and expected EM signal.

A switching arrangement comprising at least two switches 304a, 304b can be used to switch between the filters 305, 306 in the signal path.

The system 10 can further comprise a preamplifier 301 configured to amplify the received EM signal, and a mixing unit which comprises a local oscillator 302 and a mixer 303. The local oscillator 302 and the mixer 303 can be used to stepwise or continuously shift the frequency (or frequency range) of the EM signal while performing the plurality of relative power measurements via the at least one small band filter 305. The processor 309 can compare the relative power values and detect the frequency band of the EM signal in the frequency range with the maximum relative power value.

The local oscillator 302 can be a numerically clocked oscillator (NCO). The local oscillator 302 can be a tunable or swept local oscillator, i.e. a signal generator that changes its frequency over time in a controlled manner.

Alternatively or additionally to the mixing unit, the system 300 could comprise a filter bank with at least two narrow band filters 305. During the plurality of relative power measurements, the system 300 could switch between the different narrow band filters 305 of the filter bank and record a relative power measurement with each narrow band filter 305. The frequency band of the EM signal could then lie in the passband of the narrow band filter with the largest relative signal power value.

Besides the band of the EM signal, processor 309 can also detect out-of-band emissions of the DUT based on the comparison of the relative power values.

The power detector 310 can comprise an envelope detector 307 to determine a voltage signal based on the power of the EM signal and an ADC 308. The output of the ADC 308 can be fed to a processor 309.

The processor 309 can be a microprocessor or an ASIC. For instance, the processor 309 is a component of the power detector 310.

In addition or alternatively, the power detector 310 can also comprise a thermal power sensor which, however, has a relatively high setting time.

Instead of switching or mixing between the different frequency ranges during the relative power measurements, the system could also comprise multiple envelop detectors 307 and multiple ADCs 308. For instance, the multiple envelop detectors are optimized for the different frequency ranges.

The system 300 could comprise a power divider or splitter configured to feed portions of the received EM signal to the plurality of envelope detectors and ADCs which could perform power measurements in different frequency ranges simultaneously.

The system 300 can be calibrated using the calibration method 20 shown in FIG. 2.

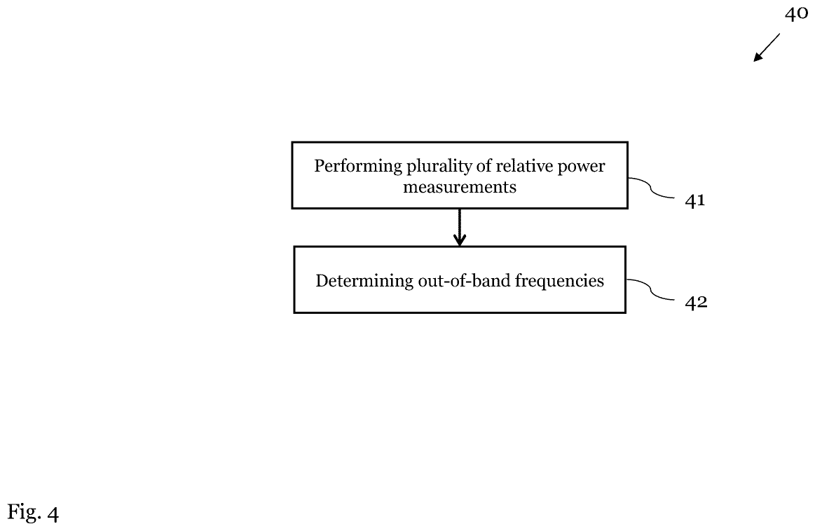

FIG. 4 shows a flow diagram of a method 40 for determining out-of-band emissions of a DUT which emits a pulsed EM signal in a known frequency band according to an embodiment.

The method 40 comprises the steps of: performing 41 a plurality of relative power measurements of the pulsed EM signal in different frequency ranges by switching at least one narrowband filter in a measurement path for the EM signal, wherein respective relative power values of the EM signal are recorded for the different frequency ranges; wherein the different frequency ranges are within a defined frequency range before and/or after the known frequency band of the EM signal; and determining 42 the out-of-band emissions of the DUT by comparing the relative power values of the EM signal recorded in the different frequency ranges.

In this way, out-of-band emissions of the DUT, such as a radar sensor that operates at a known frequency band, can be efficiently detected. For instance, the relative power measurements can be carried out within narrow frequency ranges around the known frequency band of the EM signal or in specific frequency ranges where out-of-band emissions are expected.

After detecting the out of band emissions, an absolute power measurement could be performed at the determined out-of-band frequency using a power detector which is calibrated to the out-of-band frequency.

The method 40 shown in FIG. 4 could be carried out by the system 300 shown in FIG. 3.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the present disclosure may have been disclosed with respect to only one of several implementations, such feature may be combined with one or more other features of the other implementations as may be desired and advantageous for any given or particular application.

1. A method for conducting a power measurement of a pulsed electromagnetic, EM, signal which is emitted by a device-under-test, DUT, in an unknown frequency band, comprising:
performing a plurality of relative power measurements of the pulsed EM signal in different frequency ranges by switching at least one narrowband filter in a measurement path for the EM signal, wherein respective relative power values of the EM signal are recorded for the different frequency ranges;
determining the frequency band of the pulsed EM signal by comparing the relative power values of the EM signal recorded in the different frequency ranges; and
performing an absolute power measurement of the EM signal at the determined frequency band using a power detector which is calibrated to the frequencies of the frequency band.

2. The method of claim 1,
wherein the same power detector is used for the relative power measurements and the absolute power measurement.

3. The method of claim 1,
wherein, to perform the plurality of relative power measurements at the different frequency ranges, a number of narrowband filters with different passbands are alternately switched in the measurement path for the EM signal.

4. The method of claim 3,
wherein the number of narrowband filters is arranged in a filter bank.

5. The method of claim 1,
wherein, to perform the plurality of relative power measurements at the different frequency ranges, the frequency of the EM signal is stepwise or continuously shifted and then forwarded to the at least one narrowband filter.

6. The method of claim 5,
wherein the frequency of the EM signal is stepwise or continuously shifted by means of a tunable local oscillator and a mixer.

7. The method of claim 1, further comprising:
switching from the narrowband filter to a broadband filter in the measurement path for the EM signal when performing the absolute power measurement.

8. The method of claim 1, further comprising:
additionally determining out-of-band emissions of the DUT by comparing the relative power values of the EM signal recorded in the different frequency ranges.

9. The method of claim 1,
wherein the power detector comprises at least one envelope detector and/or at least one analog-to-digital converter, ADC.

10. The method of claim 1,
wherein the power detector comprises a plurality of envelope detectors and a plurality of ADCs.

11. The method of claim 10,
wherein the power detector comprises a power divider configured to feed portions of a received signal to the plurality of envelope detectors and ADCs.

12. The method of claim 1, further comprising:
calibrating the power detector by:
feeding at least one calibration signal to the power detector, wherein the at least one calibration signal has known signal characteristics, and
correlating measurement results of the power detector to the known signal characteristics of the calibration signal.

13. A system for conducting a power measurement of a pulsed electromagnetic, EM, signal which is emitted by a device-under-test, DUT, in an unknown frequency band, comprising:
at least one narrowband filter; and
a power detector configured to perform a plurality of relative power measurements of the pulsed EM signal in different frequency ranges, wherein the at least one narrowband filter is switched in a measurement path for the EM signal during the plurality of relative power measurements;
wherein the power detector is configured to record respective relative power values of the EM signal for the different frequency ranges; and
a processor configured to determine the frequency band of the pulsed EM signal by comparing the relative power values of the EM signal recorded in the different frequency ranges;
wherein the power detector is configured to perform an absolute power measurement of the EM signal at the determined frequency band, wherein the power detector is calibrated to the frequencies of the frequency band.

14. A method for determining out-of-band emissions of a device-under-test, DUT, which emits a pulsed electromagnetic, EM, signal in a known frequency band, comprising:
performing a plurality of relative power measurements of the pulsed EM signal in different frequency ranges by switching at least one narrowband filter in a measurement path for the EM signal, wherein respective relative power values of the EM signal are recorded for the different frequency ranges;
wherein the different frequency ranges are within a defined frequency range before and/or after the known frequency band of the EM signal; and
determining the out-of-band emissions of the DUT by comparing the relative power values of the EM signal recorded in the different frequency ranges.
